(19) United States
(12) Patent Application Publication
(10) Pub. No.: US 2008/0033734 A1
(43) Pub. Date: Feb. 7, 2008

(54) Internet-based system and method for transacting videogame wager contracts between remote, online skill-game players where such gaming activity occurs external to and independent of the present invention

(76) Inventor: George Dorman Carry, Alexandria, VA (US)

Correspondence Address: George D. Carry III;Apt. 202, 4862 W. Braddock Rd., Alexandria, VA, 22311, US

(21) Appl. No.: 11/487,682

(22) Filed: Jul. 18, 2006

(51) Int. Cl. G06Q 10/00; G06Q 30/00; H04L 9/00; H04K 1/00

(52) U.S. Cl. 705/1; 705/80

(57) ABSTRACT

A business model and process is described for conducting, facilitating, and enforcing negotiated wagering agreements between two or more video game players [Players] over the Internet; hereafter referred to as The Confirming Server or The Web-site. The Confirming Server allows owners of video game consoles with online gameplay capability including its library of online games, computer software games playable online, and online board game players (either free or using a pay-site) in remote locations communicating over their personal computer devices and/or online game playing feature of their personal video game console to negotiate and enforce the terms of a wagering, loser-pays-winner, agreement that is determined upon the reported outcome of their anticipated gaming-competition [the Gaming Event]. The actual Gaming Event is played and occurs external to and independent of The Confirming Server.

### FIELD OF THE INVENTION

The present invention [The Confirming Server] generally relates to systems and methods of transacting wagering contracts over the Internet between remote online skill-game players, and particularly to a system and method wherein information identifying the outcome of the Gaming Event is required from all the players. This outcome information [Conforming Outcome Messages], if conforming (and confirmed), identifies a Winning Player who will be paid the wagered funds. The Confirming Server will enforce its rules which underscore and promote the necessity for conforming outcome information regarding the Gaming Event through a penalty system namely the Watch List and its Warning System.

### BACKGROUND OF THE INVENTION

The electronic and video game demographic has grown up. The average age of the videogame player is now 29 years old. With the advent of online video game playing and the continuing rise of free Internet game playing, adult video game players increasingly engage gaming activity where one ever-present aspect of the encounter is competition. Video game players now measure their gaming skills against other players all over the world. However, adult online game players are currently limited to playing for only bragging rights, pride, high scores or points. The Confirming Server takes the competition entrenched online gaming world one step further to allow players, already investing their time and energy in their gaming craft, to raise the stakes of their gaming and play for money as well.

The gambling and wagering business is one of the most lucrative in the world. The gaming industry brings in $50 billion a year in revenue. This amount is more than the sports industry, movie industry, music industry, and theme park industry combined. Internet gambling has quickly become an industry in its own right, taking in approximately $5 billion a year. Online video games and online board games already have features enabling two remote players to compete for an overall point value redeemable with various sponsoring Internet based merchants. Moreover, Tiger Woods PGA Tour 2005 by Electronic Arts, a video game playable online using the popular Playstation2 or Xbox Live, has a feature where two online gamers can “wager” videogame play money useable within the Player's individual game (specifically, to purchase better golf clubs and other equipment to increase the skill of the Player's videogame golf persona). Ebay and other auction web-sites have facilitated buyer and seller arrangements between remote Internet users with the payment agreement left up to the transacting parties at their own risk. Finally, Fantasy Sports Leagues, run on United States' Internet servers, also allow the online players to wager money dependent upon the outcome of their season and according to their own terms as well as the terms of the enabling master Internet server due to its “game of skill” classification that makes this form of Internet gambling legal in various governing municipalities. These web-sites have flourished in e-commerce; people trust online payment mechanisms and, when formal agreements are made, sophisticated and good faith transactions can result. The present invention will combine the sensation of wagering agreements and competitive video game playing.

The present invention intends to use Letter of Credit Transaction principles to facilitate and potentially enforce wagering agreements between remote, online game players; it will incorporate the premise that video game playing is a game of skill and the idea that each Player is contracting with the other for time and a reward determined upon the reported final outcome of their Gaming Event. The Confirming Server will be the venue to which they turn to finalize and execute that agreement.

### SUMMARY OF THE INVENTION

The present invention comprises an Internet business model and system used to facilitate wagering agreements negotiated by online video game players or online board game players. The gaming console, web-site, game to be played, determination of a winner, and price of the wager will be determined by the individual Member-Players. The Players first engage each other via their respective online game playing machines (these machines include Playstation by Sony and Xbox by Microsoft with the online gaming features, any computer game software for online gaming, and any Internet based board game played using a personal computer device). If the parties agree to wager money on their gaming skills before playing each other, they will use The Confirming Server as a mutually trusted venue to create and potentially enforce their wager contract. The players will need membership accounts with The Confirming Server that will only be available to online game players 18 years old or older, and will be required to log in with their individual usernames and passwords to execute their wagering contracts. The Confirming Server will charge a small processing fee for each contract determined by the amounts wagered and/or annual membership fee.

One aspect of The Confirming Server involves a method of doing business over the Internet comprising the steps of: using webspace and a server programmed to: securely handle money payment transactions over the Internet; charge a membership fee if applicable; provide Member-Players' ability to post messages or “Challenges” to other Member-Players, posting said Challenges over The Confirming Server's webspace and/or browser including the categorization system for these Challenges in which Member-Players may search for other Member-Players; provide the method for Member-Players to accept challenges by way of either email or by In-House communication [instant messaging] through The Confirming Server; provide various gaming Contract Templates; accept completed Contract Templates submitted by the Players; accept online payment transactions such as Visa or Master Cards and Debit Cards, or other online accounts that promote safe payment transactions; provide the parties with a detailed accounting of how much The Confirming Server will charge as a processing fee or commission for their proposed contract if applicable; communicate to the parties the terms and conditions of using the Conforming Outcome Message notification system; provide the parties the terms of their individual agreement; charge the processing fee; suspend the wagers in a Pending Contracts account; and send the wagered funds to the Winning Player's membership account upon receipt of the Conforming Outcome Messages from the Member-Players.

Another aspect of The Confirming Server involves a system for conducting safe and secure payment and wagering transactions over the Internet comprising: a computer server having access to the Internet, and being programmed to communicate to Members-Players via the Internet web-site or downloaded and installed software, data representing the available selection of Contract Templates, instructions detailing how to complete the user-friendly fill-in-the-blank wagering contracts; provide and present a reputation score/rank for each Member-Player based on a ratio or formula interpreting Member/Players' total contracts and any breach of those contracts, an electronic signature feature whereby Member-Players promise to perform their contract obligations, particularly to participate in the Gaming Event and then send in (to The Confirming Server) the Outcome Information that constitutes Conforming Outcome Messages; the computer/Internet server being programmed to accept safe and secure money deposits and withdrawals, verify conformance in the Conforming Outcome Messages, and to maintain an accessible record of contract history and account information for each Member-Player.

Another aspect of The Confirming Server involves a system for implementing, conducting, and verifying conformity in the Conforming Outcome Messages notification process feature of the transaction comprising the steps of a computer server, browser, and/or master controller being programmed to: provide a summary of the Member-Players' wagering agreement; communicate, present, and apply the Outcome Information notification system; communicate, present, and apply the terms for breach of the wagering agreement; communicate, present, and apply the terms for being placed on the Watch-List and subject to application of the Warning System; communicate and present to the Member-Players, and apply the terms and applications of the ⅓ Ripe Wagering-Contract Rule or Ripe-Time Rule; sending a summary of the Member-Players' wagering agreement to their individual email accounts, pre-registered as part of membership status, and/or a notification method through downloaded and installed software; communicating the process for how each Member-Player will fulfill their outcome notification obligations; quick and easy method for Member-Players to submit their Conforming Outcome Messages to The Confirmer Server (either by email reply, email forward, or by using an In-House [defined as, within the downloaded and installed software browser and/or Internet web-site] method of notification programmed into The Confirming Server's database, web browser software web-domain, web-pages, and/or computer/Internet server.

The Confirming Server's computer/Internet server will be programmed to institute the following Conforming Outcome Message obligations: communicating to the member-Players(1) that in the event that only one of the Member-Players (or one team of Member-Players for multiplayer Gaming Events) submits the required Outcome Information, it is the complying/non-breaching Member-Player(s) The Confirming Server will deem the Winning Player(s) and subsequent recipient of the wagered money amounts; (2) that in the event the Member-Players tender back to The Confirming Server conflicting or otherwise non-conforming Outcome Information pertaining to their Gaming Event, the contract will be voided subject to any fee, and both or all Member-Players involved in the disputed Gaming Event will be deemed in breach and become breaching Member-Players regardless of Actual Outcome; (3) any breaching Member-Player will automatically be placed on the Watch List and become subject to its Warning System; (3(a)) these warnings will appear before final entry of any contract and suspending of wagered funds involving the breaching Member-Player and an unknowing/Member-Player and will last for two weeks (or other time) after the first breach; (3(b)) these warnings will last for one month (or other time and may potentially involve higher processing fees) after a Member-Player's second breach; and (4) in the event any Member-Player breaches the terms of The Confirming Server including the Conforming Outcome Message requirement three times in a six month period (or other specified period), that repeating breaching Member-Player will have his membership suspended or will otherwise be penalized. These rules and penalties will apply in accordance with any other rules to necessitate good faith, sophisticated wagering arrangements between adult video game players.

Methods and systems are thus described wherein remote online game (audio/visual or electronic board) players participate in their selected mutual and/or collateral activity, and the information pertaining to the outcomes of which, submitted by the participating players, are used to determine the ultimate recipient of wagered money. Other objects of the present invention will be apparent from the detailed description that follows when read in conjunction with the associated drawings.

### BRIEF DESCRIPTION OF THE DRAWINGS

FIG. 1 is a flow-chart illustrating the general steps involved in a typical online Gaming Event and wagering transaction performed in accordance with the concepts of the present invention.

FIG. 2 is a block diagram showing an embodiment of The Confirming Server as used in accordance with the systems and methods described herein when two Member-Players are using their personal video game consoles/machines with online game playing capability.

FIG. 3 is a block diagram showing an embodiment of The Confirming Server as used in accordance with the systems and methods described herein when two Member-Players are using their personal computer devices with an Internet connection to play a computer game that is playable online of which they have previously purchased and installed.

FIG. 4 is a block diagram showing an embodiment of The Confirming Server as used in accordance with the systems and methods described herein when two Member-Players are using their personal computer devices with an Internet connection to play free or pay-site electronic or board games.

FIG. 5 is a block diagram showing an embodiment of a master controller centralized server as used in accordance with the present invention

FIG. 6 illustrates the aspect of the invention pertaining to the fill-in-the-blank wagering Contract Templates, particularly for an online football game (bracketed wording is instructive).

### DETAILED DESCRIPTION

The present invention describes business systems and business methods—processes for conducting wagering transactions wherein two or more, remote, online video game players using their personal online video game consoles/machines or personal computer devices agree on the terms of their wagering contract including the further obligation to submit the outcome information back to the present invention which will then pay the winning player the wagered amounts. The present invention does not interface with any online video game console/machine. The present invention exists and is practiced as programmed software potentially involving a database, web domain, web page(s), and/or computer/Internet server accessible via the global communications network or Internet in the form of web pages within a web domain potentially run by a computer/Internet server, or in the form of downloaded and installed user-friendly software with its own browser that connects to and/or is potentially run by a computer/Internet server. A centralized server or master-controller may be implemented to manage all transactions, and allowing potential access to the invention through various already existing Internet portals or other e-commerce web-sites. Such control also fosters efficient management of quality control, qualified membership screening, association and communication between members, and other customer-service data control concerns.

The Confirming Server is intended for those purchasers and owners of video game consoles/machines with online game playing capabilities including its respective library of games playable online, computer software games that are playable online, and those playing online board games. And, limited only to those games where one individual Winning Player (or team of players if the game is a multiplayer game or tournament) will prevail at the conclusion of the Gaming Event. The Confirming Server enables remote, online Players to negotiate the terms of their agreement to be based on the outcome of their anticipated gaming-competition; the Gaming Event. Players will need an online membership-account with The Confirming Server in order to enter wagering contracts and deposit and withdraw monetary funds. The Confirming Server will employ and apply current conversion rates in cases involving different currency to ensure fair wagering.

The Confirming Server is intended for Players to enter into good faith mutual promises to perform according to the individual and variable terms of their contract supported by the principles of letter of credit transactions. Both Players (or all Players in a multiplayer event) become obligated via their agreement, signed by electronic signature coupled with the start performance of paying their wagered money amounts into The Confirming Server's Pending Contracts Account.

The Confirming Server will also employ a method for rating Member-Players' reputations for complying with the rules and regulations of The Confirming Server. One's reputation score or rank represents his or her history for either complying or breaching the outcome messaging system. Member-Players use the reputation scores in deciding whether to contract with a certain Member-Player. This is will prove to be important information because it is all parties to a contract that are in breach when The Confirming Server receives conflicting outcome information, therefore one's own reputation is at stake in every gaming contract and will depend on the other party's or parties' compliance with the rules.

At the conclusion of their Gaming Event, the Players are further obligated to notify The Confirmning Server of the Outcome Information by sending in [to The Confirming Server database] Conforming Outcome Messages that all designate the Winning Player entitled to the total amount wagered. The Conforming Outcome Messages may be submitted via an email reply, email forward, or by using an In-House [defined as, within the downloaded software and/or browser] method of notification programmed into The Confirming Server's database, web domain, web pages, and/or Internet server. The Confirming Server has provisions in place for any breach of the wagering agreement that foster sophisticated, good faith transacting. The Confirming Server examines and verifies conformance in the Conforming Outcome Messages and pays the winnings to the Winning Player's membership account. The Confirming Server may also, when a particular Game provides an unmodifiable and tamperproof record of wins and losses for online game players' accounts, require Member-Players to enter in their win/loss record in the Wagering-Contract whereby The Confirming Server may access the gaming network using The Confirming Server's game consoles or computers, search the appropriate game network for the Member-Players involved, verify the entered win/loss records, and, after the Outcome Information is received, check the win/loss records for the correct change in the win and loss columns (assuming all the necessary licenses and permissions have been negotiated).

The Confirming Server has templates for generic gaming contracts to be electronically filled out by the two Players. The Confirming Server has “Chat” capabilities enabling communication between the players during the negotiation process. The Confirming Server also has Challenge Posts whereby Member-Players can offer and accept Gaming Events and/or wagers. The Confirming Server is intended solely for electronic, audio/visual games involving skill, and not as a means for members to engage in illegal gambling activity such as sports betting or any traditional game of chance or casino activity, including poker.

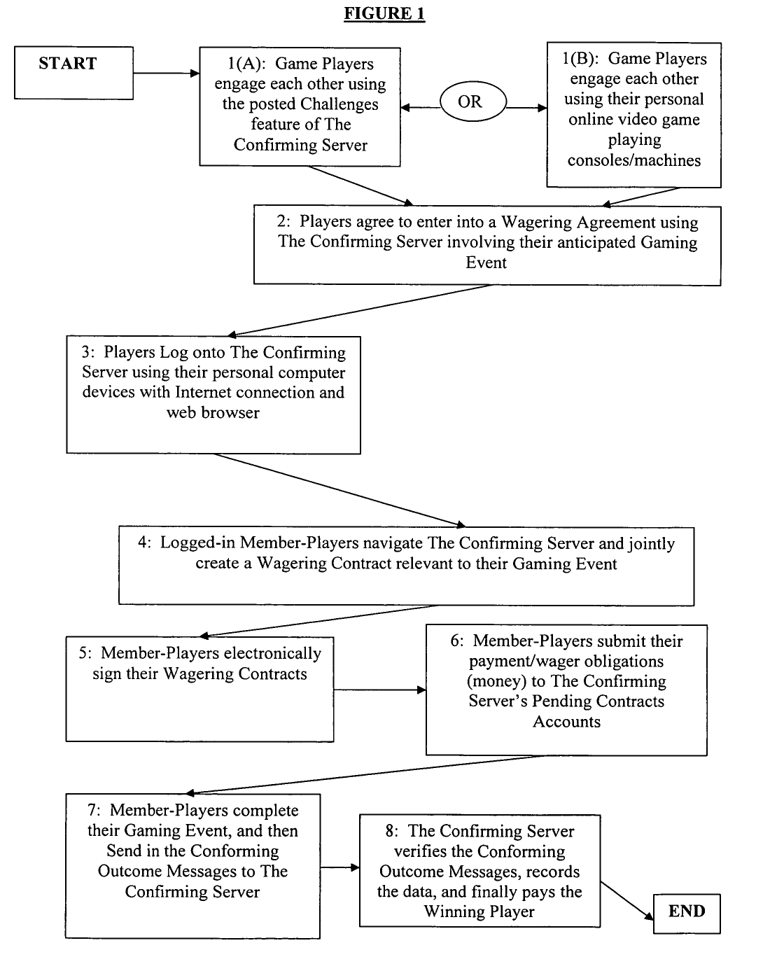

Turning to FIG. 1, a flow-chart is shown illustrating a typical transaction performed in accordance with the concepts and system of the present invention [The Confirming Server]. At Step 1, the online video game players [Players] first encounter each other in one of two ways: Step 1(A) illustrates Players first engaging each other using the Searchable Posted Challenges feature of The Confirming Server that categorizes these Challenges according to video game playing console/machine, video game playing console/machine and compatible game, game, computer game, and Internet games from either pay-sites or free sites, and Step 1(B) depicts Players first engaging each other via their personal video game consoles/machines with online game playing components, computer game, or Internet game. The Players are able to communicate to each other using internet lines connected to their video game console or personal computer device, personal phone lines, Chat or Texting features on their video game console/machine or personal computer device, the Chat feature employed by The Confirming Server, and/or other Internet-messaging methods.

At Step 2, the Players by way of their respective communication method next agree to enter into a wagering agreement dependent upon the outcome of their anticipated Gaming Event that will be facilitated and enforced by The Confirming Server. Players will need to become Member-Players through qualified membership screening including but not limited to an age verification process practiced in accordance with current standards in e-commerce. Member-Players log onto The Confirming Server using their personal computer devices and/or web browsers as seen in Step 3.

At Step 4, logged-in Member-Players use their personal computer devices and/or web browser to navigate The Confirming Server, create wagering contracts, and deposit or withdraw money funds using their account. This payment information may be input and processed using well-known e-commerce financial software and programming that incorporates integrated or independent encryption technology. This payment process may occur at any stage in The Confirming Server's process, but must occur prior to Submitting complete wagering agreements and suspending the wagered funds. Member-Players can meet/encounter/engage each other in a searchable virtual lobby area with In-House Chat capability. Member-Players then select the appropriate Contract Template according to the online gaming device they use and the game to be played (a Winning Player must be identifiable by the Member-Players involved in the wagering arrangement at the conclusion of the Gaming Event as these will be the only games considered compatible with The Confirming Server's system and business method). Member-Players negotiate the terms of their wagering contract by completing the fill-in-the-blank Contract Templates using the In-house Chat function or any other communication method the Member-Players may choose.

The various Contract Templates include but are not limited to: Football game Contracts, Multiplayer Football game Contracts, Basketball game Contracts, Multiplayer Basketball game Contracts, Baseball game Contracts, Multiplayer Baseball game Contracts, One-on-One Golf Contracts, Multiplayer Golf Contracts, Tournament Golf Contracts, Generic Sport Event game Contracts, Multiplayer Generic Sport Event game Contracts, One-on-one Combat game Contracts, Multiplayer Combat game Contracts, Board game Contracts, Multiplayer Board game Contracts, High Scorer game Contracts and Multiplayer High Scorer game Contracts (for those video or board games where a Winning Player is identified as the player who accumulated the most points as against the gaming software itself and not dependent on another player's collateral-gaming), and/or a general fill-in-the-blank game contract where the Member-Players fill in the type of game and other appropriate information regarding their transaction.

Every Contract Template will have pull down menu choices or any other similar method that communicates and presents that the potential following terms are required in an enforceable wagering contract: type of online gaming device, the game to be played, how the Winning Player is determined, amounts wagered, the Member-Players' promises to send in the Outcome Information via The Confirming Server's Conforming Outcome Messaging methods and systems, the Member-Players' win/loss records (if applicable and agreed upon), a time limit for complying with the Conforming Outcome Messaging requirements after the Point-of-No-Return deadline, an acknowledgement by the Member-Players that they know and understand the terms and conditions of their agreement including The Confirming Server's remedies for any default, and a final opportunity to inspect the terms of their agreement before paying in any wagering funds.

At Step 5, the Member-Players electronically sign their contracts. The electronic signature represents the contracting Member-Players' manifestation of their intent to be bound by the terms of their agreement. The electronic signature will consist of each Member-Player typing their usemame and for verification purposes their password and/or last four digits of their social security number or any other similar method that amounts to this manifestation of intent.

At Step 6, after electronically signing, the Member-Players then click to Submit their payment/wager obligations in the form of monetary funds (already deposited into the Member-Players' membership accounts) to The Confirming Server's Pending Contracts Account where the risked funds will remain until The Confirming Server receives the Conforming Outcome Messages or the system becomes otherwise complete (e.g., in the event of a breach). This information regarding suspending wagered funds and the Pending Contracts Account may be input, processed, and employed using well-known e-commerce financial software that takes advantage of integrated and independent encryption technology.

At Step 7, the Member-Players have played and/or otherwise completed their Gaming Event and will then need to fulfill the Conforming Outcome Message requirement by satisfactorily communicating the Outcome Information back to The Confirming Server. Effective and conforming Outcome Information is communicated back to The Confirming Server in the form of an email reply or email forward identifying the Winning Player and including the appropriate authentication information including but not limited to a password, last four digits of their social security number, and/or authentication code. These said replies and forwards will involve the email message sent from The Confirming Server to the individual Member-Players' personal email accounts (the same email accounts used when obtaining their membership status) that summarizes the terms of the wagering agreement and has a designated area to enter in the required Outcome Information. Another effective and Conforming Outcome Messaging method will consist of Member-Players logging back onto The Confirming Server, accessing their personal membership accounts, locating the folder or webpage that contains Member-Player Suspended-Funds information and click on the appropriate image, link, and/or pull-down menu choice that will automatically communicate to The Confirming Server the appropriate Outcome Information pertaining to those suspended funds.

The Confirming Server will then pay the suspended wagered money to the Winning Player's membership account upon receipt and completed computer programmed inspection, authentication, and verification of conformity in the Conforming Outcome Messaging information, as seen in Step 8. The funds will then become eligible for withdraw or further online game wagering with another Member-Player, or, in the event both Member-Players agree, they can take advantage of the “Double or Nothing” feature of The Confirming Server.

The Confirming Server will keep records and information regarding business transactions and other practices in accordance with well-known commercial standards.

The following example will illustrate in more detail the transaction that occurs between the online video game playing Member-Players depicted in the FIG. 1 flow-chart. Abe from Virginia and Ben from California both have membership accounts with The Confirming Server. Abe and Ben each own a Sony Playstation2 console with online gaming network features. They are both Madden Football (Electronic Arts) enthusiasts having bought the latest release, Madden NFL 2006 (Electronic Arts), which is also playable over Playstation's online gaming network. Abe and Ben encounter each other after turning on their Playstation2 consoles and signing onto its online gaming network interfaced with its Madden football game (Step 1(B)). This Playstation online gaming network has Chat or Texting features whereby Players can communicate with each other. Players may also communicate via phone lines or any online instant messaging program. Abe and Ben chat with each other about how good they are at Madden football and how they are beginning to tire with just beating other players. Abe and Ben, both believing they each possess the superior gaming skills for Madden football, decide to wager on their anticipated online competition (Step 2). Alternatively, either Abe or Ben could have previously logged onto The Confirming Server using their personal computer devices with Internet browsing software, and may have posted a Challenge and either of the two Players may have accepted the Challenge where they can then proceed to decide to enter the wagering agreement (Step 1(A) and Step 2).

Abe and Ben have now accessed the Internet using a typical personal computer device with a web browser. Abe and Ben then send a request through their browsers to link to a web-site implementing the functions of this present invention including FIG. 1. For this example, the web-site will be called www.gameconfirmer.com (No such web-site is known to exist at this time). Alternatively, Abe and Ben may have already downloaded and installed the gameconfirmer.com user-friendly software that connects to and/or is run by The Confirming Server's Internet/server as part of their gaining membership status (Step 3).

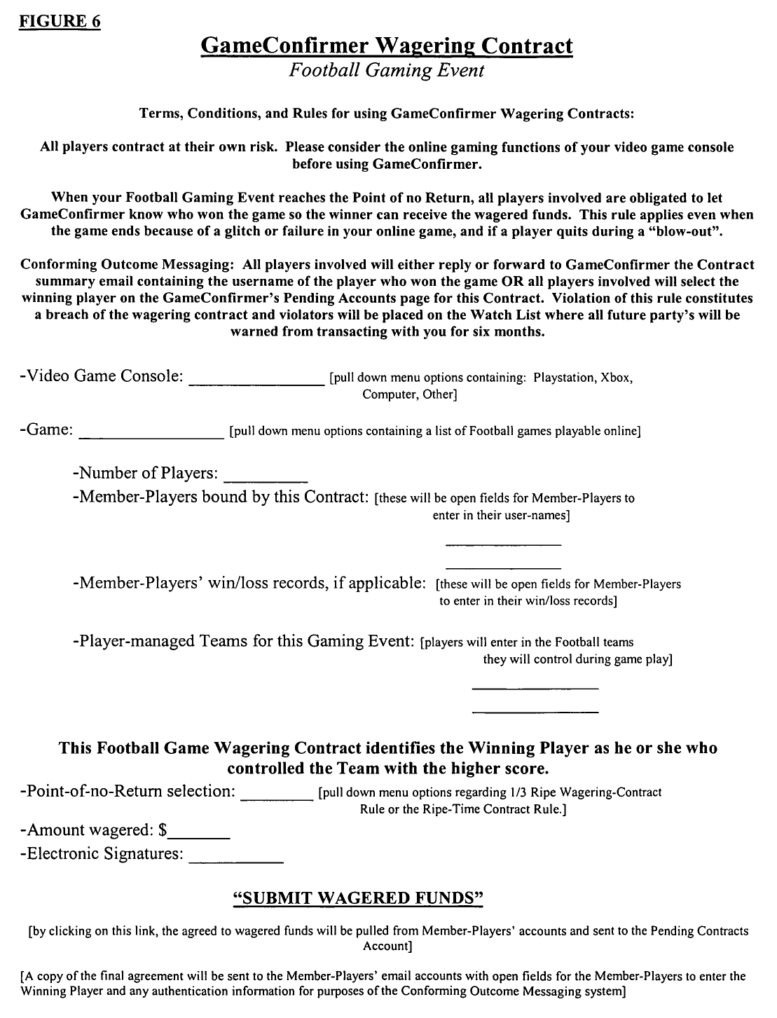

Abe and Ben then navigate the web-site or their downloaded and installed software both of which are connected to The Confirming Server's web pages, web domain and/or Internet/server. They find each other in the virtual Lobby of the web-site or browser and are satisfied with their respective reputation scores (Abe has 4.5 out of 5 stars because he was a party to one breached contract out of the 25 he has entered into, and Ben has 5 stars as his reputation score because he has never been involved in a breached contract). Abe and Ben are comfortable with each others' reputations for compliance and decide to continue with their wagering agreement They then locate the web-page browser ‘button’ for Playstation2, click on it, and are then presented with a pull-down menu, or another similar method for, communicating the available contract templates regarding Playstation2 online gaming. Abe and Ben, using the Chat feature of the web-site or the downloaded and installed software program negotiate the fill in the blanks of a Football game Contract according to their terms. They fill in the appropriate information regarding how and under what terms a Winning Player will be determined (similar to FIG. 6). Abe and Ben agree to wager $150.00 on their football game and enter this amount in the appropriate place on their contract.

Abe and Ben will then need to send in their VISA card information (or other payment information) to their personal gameconfirmer.com accounts by way of the gameconfirmer.com server if their accounts do not already have the necessary funds to cover and satisfy their wagering contract. Of course, this step may occur at any time during a Member-Player's logged-on use of The Confirming Server. Abe and Ben then electronically sign their contract and then click on “Submit Wagered Funds”. Abe and Ben will then each encounter via their personal computer devices short, concise, and easy-to-follow instructions regarding the additional obligation of sending in the Conforming Outcome Messages. For example, Abe will see an instruction similar to, “At the conclusion of your Gaming Event, you, Abe, are responsible for filling in the Winning Player information in the email you will receive from gameconfirmer.com at the end of your negotiation, OR you, Abe, may click on the ‘Enter Winning Player Information’ link located at the top right hand corner of your account homepage.” Ben will see the same messages containing his own name. Gameconfirmer.com will then list the penalties for failing to fulfill their obligation to notify the server of the Outcome Information. Abe and Ben will then, again, electronically sign the contracts (Step 5) and click on the “In Agreement, Let's Play” link. Upon doing this, the wagered amounts will be pulled from their membership accounts, and held by The Confirming Server until a Winning Player is identified (Step 6).

Abe and Ben then pick up their Playstation2 controllers, using the Sony online gaming network, and play their game. Abe wins. Abe and Ben can then either log into their personal email accounts to reply to or forward to www.gameconfirmer.com the Outcome Information or they both can log back on to www.gameconfirmer.com, access their membership account homepage, click the “Enter Winning Player Information” link and report in the Outcome Information; that Abe was the Winning Player (Step 7).

Once the www.gameconfirmer.com server has determined that the Outcome Information is conforming, it will confirm and complete the transaction by issuing the wagered funds into the Winning Player's membership account using the programmed web pages, web domain, and/or computer/Internet server either accessed via the Internet or downloaded software installed on a personal computer device according to the system and methods described herein (Step 8).

Member-Players have personal knowledge regarding how their video game consoles/machines or personal computer devices perform during online gaming activity. Member-Players will also understand that The Confirming Server does not interface with the online gaming activity provided by their video game consoles or personal computer devices; meaning their Gaming Event occurs independent and external from The Confirming Server. Upon these premises, Member-Players will understand that they use The Confirming Server and enter into Wagering Contracts at their own risk and subject to the conditions and any potential malfunctioning that occurs during their external and independent Gaming Event. This Warning will be conspicuously evident on every Contract Template.

The Conforming Server is intended for entertainment only. In furtherance of this premise, Member-Players will not be responsible for unintentional glitches in the gaming network they choose; meaning, that the wagering contracts will be voided if either player loses their network connection, but not when the ⅓ Ripe Wagering-Contract Rule or Ripe-Time Rule applies. The Wagering Contract ripens after ⅓ of a Complete Gaming Event occurs and will not be voided irrespective of intent or glitch. The Wagering Contract may also ripen upon expiration of an agreed to, specified time limit accruing from the point when the wagered funds were submitted. This default precaution protects winning players during “blow-out” situations where a game becomes un-winnable and time remains on the clock so the game is not over. The ⅓ Ripe Wagering-Contract Rule or Ripe-Time will apply in all situations where a game is otherwise terminated and/or network connectivity is lost; both Players will remain obligated to fulfill the Conforming Outcome Message requirement. The Confirming Server will have a time-keeping mechanism that will automatically start (or delayed start if otherwise agreed) upon submitting the final contracts.

The ⅓ Ripe Wagering-Contract Rule and Ripe-Time Rule apply alongside and in accordance with the other default rules outlined in Paragraph [0009] that apply when The Confirming Server receives incomplete or conflicting Outcome Information. Furthermore, if both Member-Players (or both teams in a multiplayer game) submit conflicting or non-conforming Outcome Information, Member-Players may agree to be bound by The Confirming Server's determination of Winning Player. The Confirming Server will ‘hear’ both sides via email communication with the Domain Master, Customer Service, Controller, Web host, or any other similar method for communication between Member-Players and The Confirming Server. However, in cases where Member-Players insist that they each won or otherwise cannot agree on who was the Winning Player, then The Confirming Server will void the wagering contract, all Member-Players involved in this voided contract are breaching Member-Players, and will be put on the Watch List database as part of the overall Confirming Server's programmed software, web-site, web domain, and/or computer/Internet server.

All of the previously mentioned default rules will consistently be communicated and presented to Member-Players before contract negotiation, during contract negotiation, before electronically signing, and/or before clicking the “In Agreement, Let's Play” link that finalizes their wagering contract.

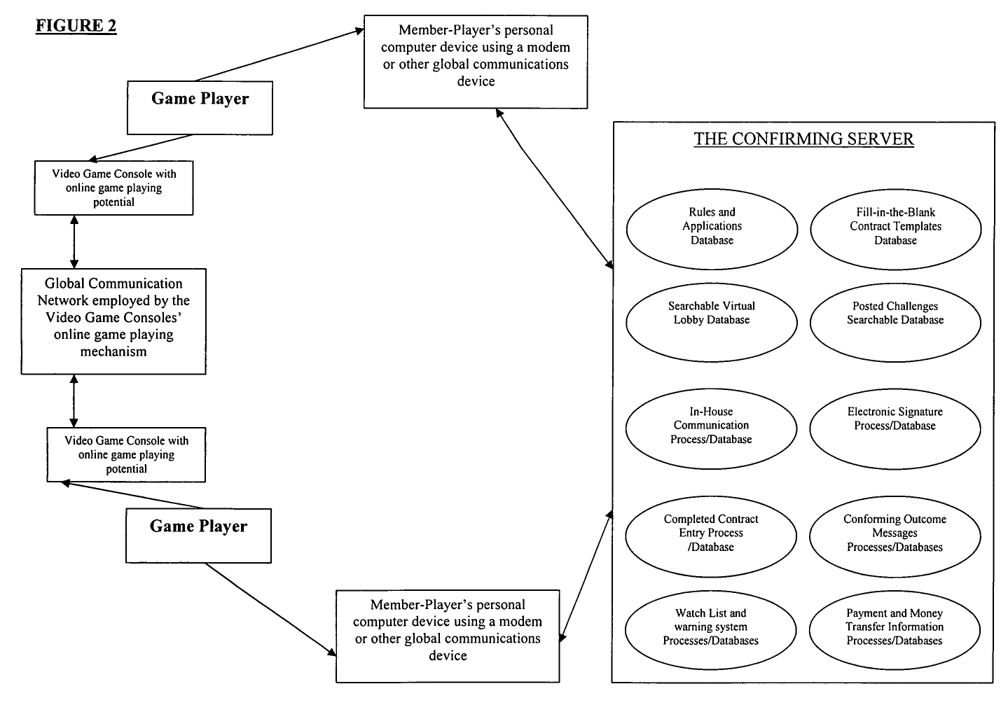

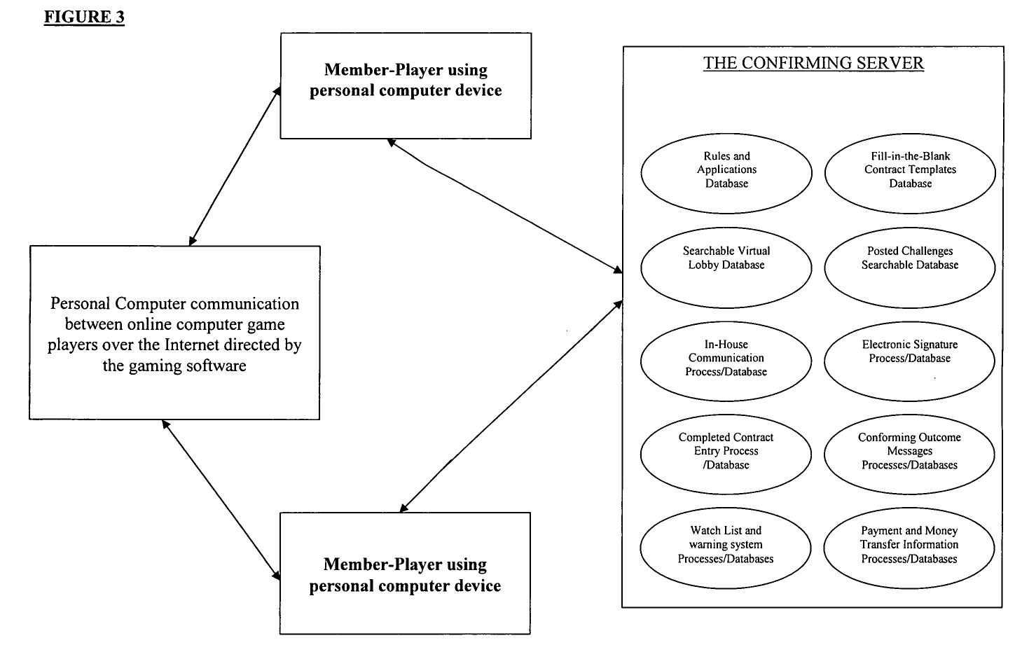

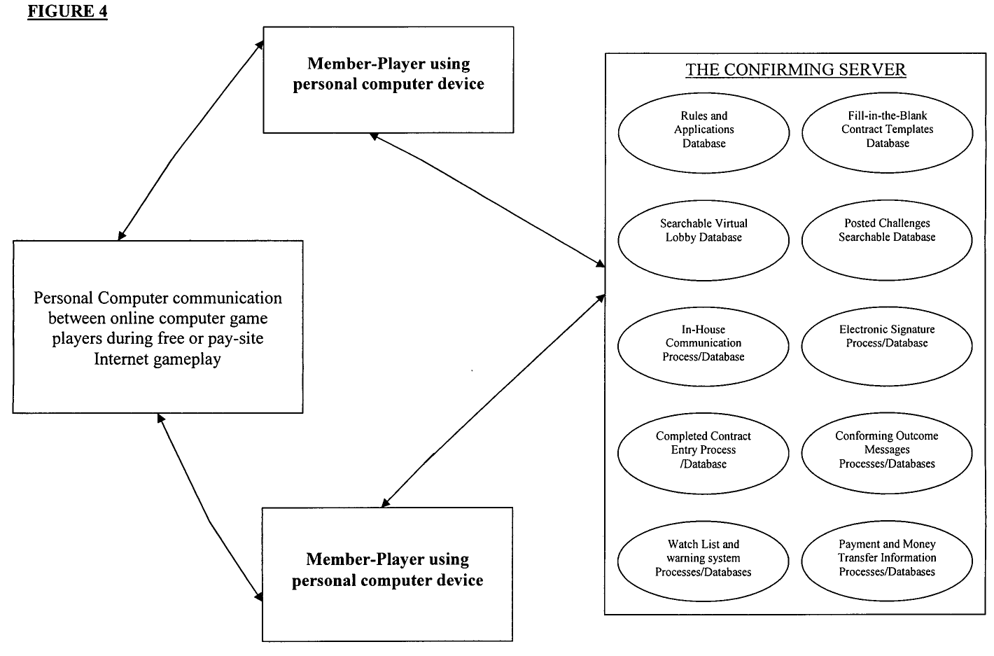

FIG. 2, FIG. 3, and FIG. 4 are block diagrams showing an embodiment of the Confirming Server as used in accordance with the systems and methods described herein when two Member-Players are using their personal video game consoles/machines with an online gaming feature, as seen in FIG. 2; when two Member-Players are using their personal computer devices with an Internet connection to play a computer game able to be played online of which they have installed, as seen in FIG. 3; and when the two Member-Players are using their personal computer devices with an Internet connection to play free or pay-site to play electronic or board games, as seen in FIG. 4. These block diagrams are used to illustrate the fact that The Confirming Server and the wagered-on Gaming Event occur independent of each other by way of each Player's Fair Use of his or her purchased videogame console, personal computer device, computer game software, or Internet game playing. The Confirming Site does not interface with any online game playing machine or device including but not limited to Playstation2, Xbox, Computer software game, online web domain for Internet gaming, online server for Internet gaming, or downloaded and installed online gaming software.

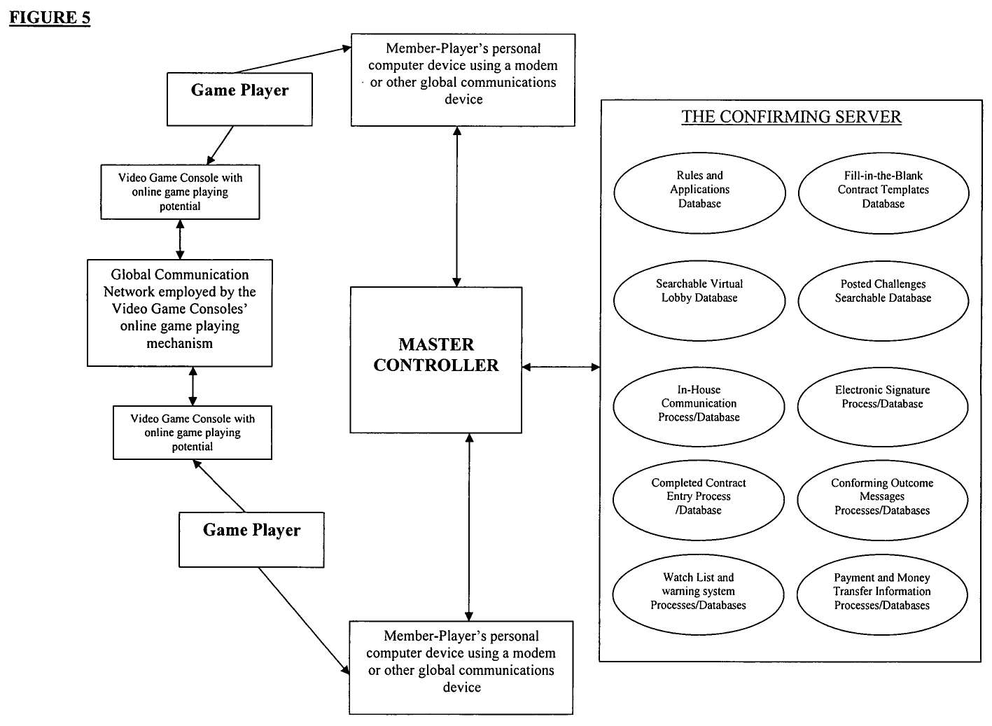

As previously mentioned, The Confirming Server's transactions may be handled by a master operation controller or content server for efficient processing and marketability. FIG. 5 is a block diagram showing one embodiment of a master controller as used in accordance with the present invention. The master controller may be a computer server which provides content to and manages a web-site implementing the concepts of the system and methods described herein. The Member-Players connection to The Confirming Server may comprise a personal computer device connected to the master controller, and may each have browser software installed that was made available for download from The Confirming Server's web-site. The connection may be via an electronic network interface and connection to a modem or other communication device which in turn is connected to the content server via any Internet connection including phone lines and cable lines. Connection to the master controller may be directly via an Internet connection, and may occur via a hyperlink from another web-site behaving as a front-end to the master controller. In an exemplary embodiment, Member-Players simply need to have Internet access and browser software installed, to allow the Member-Players to navigate the Internet and access a web-site hosting content which implements the system and methods of The Confirming Server.

The Confirming Server practiced as a web-site, installed browser software, with or without a content server/master controller and/or computer server has access to the main database which comprises the Rules and Applications database, Searchable Virtual Lobby feature/database, Searchable Posted Challenges feature/database, Member Account database, Pending Contracts Account database, Electronic Signature feature/database, Payment and Money Transfer Information and Processes, Breaching Member-Player Watch-list database, Fill-in-the-Blank Contract Templates database, In-House Communication or Chat feature/database, Completed Contract Entry feature/database, Conforming Outcome Messaging System including verification and authentication processes, and an incentive system for rewarding Member-Players' compliance with terms and rules. The relationships between the various databases may be programmed using well-known programming techniques.

FIG. 6 is a sample Contract Template for an online football game. All other Contract Templates will be of similar design, style, will communicate to the Member-Players the formalities of the entire process including the Conforming Outcome Messaging requirement, as well as variable rules for determining the Winning Player dependent upon the upcoming Gaming Event. For example, with a football game, the Winning Player will be the Member-Player controlling the winning team, designated by higher score, at the end of 4 quarters of video game football; however, with a one-on-one combat game, the Winning Player will be the Member-Player controlling the winning video game character, designated by knocking out or otherwise defeating the opponent video game character the sufficient number of times as required by the video game itself or by the contracting Member-Players.

Wagering Contract Templates may be added, modified, and/or deleted. The availability of any given Contract Template may also change and be set based upon any combination of the associated Gaming Event, the identity of the Member-Player, the skill level of the Member-Player, the number of Member-Players involved, and many other external factors. It is preferred and expected that the rules explaining proper and legal use of The Confirming Server are communicated to the Member-Players prior to suspended wagered funds. This will likely facilitate the creation of a binding contract upon both Member-Players.

The Member-Players may be required to pay a fee based on their use of The Confirming Server. The fee may be based upon a pay-per-contract, a predetermined processing fee defined by a percentage of the total amount wagered, and/or an annual, bi-annually, monthly, or other membership fee at the discretion of the inventor or his licensee.

The Confirming Server may have varying rules, servers, web-domains, web-pages, and/or web-sites regarding fee structure dependent upon the legality of wagering/gambling agreements in any given state, county, district, city, town, or territory within the United States or any other country in the world. This will promote marketability and customer assurance when The Confirming Server complies with local laws. For example, The Confirming Server may employ a server programmed to charge a pay-per-contract fee structure because the state's gambling law dictates that no gambling entity may charge a “rake” [defined as, a processing fee assessed according to a percentage of the total amount wagered]. However, in another state, The Confirming Server may employ a server programmed to charge a “rake” because the Gaming Events compatible with The Confirming Server are all games of skill and not deemed games of chance by the state. In other words, the claims and rights contemplated in this patent include different versions of The Confirming Server where such difference is attributable to the method The Confirming Server receives money as payment for its services.

While certain embodiments are illustrated in the drawings and are described herein, including preferred or exemplary embodiments, it will be apparent to those skilled in the art that the specific embodiments described herein may be modified without departing from the inventive concepts described. For example, well-known e-commerce software for secure payment transactions, member account management, customer service, security, general ledger, and other applications may be integrated into an overall e-commerce application package to provide a complete e-commerce solution for a business desiring to capitalize on the concepts, systems, and methods described herein. Additionally, software implementing the concepts, systems, and methods described herein may generally be programmed to allow exit or logout at

What is claimed is:

1. A method of doing business over the Internet comprising the steps: using a computer server, browser, and/or master controller programmed to: securely handle money payment transactions over the Internet; provide Member-Players' ability to post messages and/or Challenges to other Member-Players and/or a message post; provide Member-Players the option of searching for other friend/Member-Players already logged-in to The Confirming Server; provide various fill-in-the-blank Contract Templates; accept completed Contract Templates submitted by Member-Players; accept online payment transactions; apply the terms and rules for wagering that are communicated and presented to Member-Players; communicate to Member-Players general information pertaining to management of accounts, membership fees and/or processing fees, account history, and completed contracts; communicate to the Member-Players the terms and conditions of using the Conforming Outcome Messages notification system and method; provide and maintain segregated Member-Player accounts; provide and present the final version of their agreement before and after the Gaming Event for purposes of the Conforming Outcome Messages system; charge a processing fee, commission and/or a membership fee; suspend the wagered funds in a Pending Contracts account; and send the wagered funds to the Winning Player's membership account upon receipt, authentication, and verification of conforming Outcome Information received from the Member-Players.

2. The method of claim 1, further comprising the step of a computer server, browser, and/or master controller being programmed to enable a message posting Challenge feature that is categorized and searchable according to video game console/machine, video game console/machine and compatible game, game, computer game, and Internet game.

3. The method of claim 2, further comprising the step of a computer server, browser, and/or master controller being programmed to provide an In-House Chat feature [defined as instant messaging within and a part of the web-space and/or a downloaded and installed software browser] that enables Member-Player communication with each other and with the The Confirming Server over The Confirming Server's web-site and/or browser.

4. The method of claim 1, further comprising the step of a computer server, browser, and/or master controller being programmed to present and apply The Confirming Server's rules to the Member-Players over the Internet.

5. The method of claim 1 further comprising the step of a computer server, browser, and/or master controller being programmed to maintain, manage, and move money accounts and amounts in cyberspace, using the Internet network, bank, and/or wire communication systems.

6. The method of claim 1, wherein the Gaming Event is played or occurs over the Internet as free web-site gaming, pay-web-site gaming, a free downloaded and installed gaming software from an Internet site, or purchased downloaded and installed gaming software from an Internet site using personal computer devices such as desktop personal computers or notebook/laptop personal computers as purchased

7. The method of claim 1, wherein the Gaming Event is played or occurs using rented, purchased, or otherwise possessed video game consoles/machines that will employ its own system and/or network for playing its own game library, online and against another game player using his or her own video game console/machine and playing the same compatible game.

8. A method of creating and executing safe and secure wagering agreements between Member-Players comprising the steps: of a computer server, browser, and/or master controller having access to the Internet, and being programmed to communicate to Member-Players via the Internet web-site or downloaded software, data representing the available selection of Contract Templates, instructions detailing how to complete the user-friendly fill-in-the-blank wagering Contract Templates, an electronic signature feature whereby Member-Players promise to perform their contract obligations (participation in the Gaming Event and subsequent notification of the Outcome Information that constitutes Conforming Outcome Messages); the computer/Internet server being programmed to implement the Watch List and Warning System; accept completed wagering contracts, provide and present a reputation score or rank for each Member-Player, accept safe and secure money deposits and withdrawals, send summaries of completed contracts to Member-Players, authenticate the Conforming Outcome Messages, verify conformance in the Conforming Outcome Messages, resolve disputes regarding conflicting Outcome Information when applicable, and to maintain an accessible record of contract history and account information for each Member-Player.

9. The method of claim 8, further comprising the step of receiving data over the Internet representing a decision by the Member-Players to enter into a wagering contract using The Confirming Server.

10. The method of claim 8, further comprising the step of sending the final version of the wagering contracts to all Member-Players involved for Conforming Outcome Messaging purposes over the Internet via the In-House communication method and/or email systems.

11. The method of claim 8 wherein the reputation score/rank pertaining to every Member-Player is based on a ratio taking into account contracts entered into and whether a breach resulted (or any other formula whereby Member-Players have a reputation affixed to their Member-usernames representing their probable compliance with The Confirming Server's rules and regulations, such as submitting Conforming Outcome Messages) and takes the form of either a star system, percentage, or any other form communicating a score.

12. The method of claim 8, further comprising the step of presenting The Confirming Server's instructions regarding filling out the Contract Templates to the Member-Players over the Internet.

13. The method of claim 8, further comprising the step of The Confirming Server's web-site, server, and/or master controller being programmed using well-known computer code to verify conformance in the Outcome Information by performing a mirror-image test or other similar matching-verification test applied to all received Outcome Messages or, when a particular Game provides an unmodifiable and tamperproof record of wins and losses for online game players' accounts, The Confirming Server may require Member-Players to enter in their win/loss record in the Wagering-Contract whereby The Confirming Server may access the gaming network using The Confirming Server's game consoles or computers, search the appropriate game network for the Member-Players involved, verify the entered win/loss records, and, after the Outcome Information is received, check the win/loss records for the correct change in the win and loss columns (assuming all necessary permissions and licenses are negotiated).

14. The method of claim 8 further comprising the step of implementing and conducting the Conforming Outcome Message notification system for purposes of paying out the wagered amounts to the Winning Player comprising the steps of a computer server, browser, and/or master controller being programmed to: provide a summary of the Member-Players' wagering agreement; communicate, present, and apply the Outcome Information notification system; communicate, present, and apply the terms for breach of the wagering agreement; communicate, present, and apply the terms for being placed on the Watch-List and subject to application of the Warning System; and communicate and present to the Member-Players, and apply the terms and applications of the ⅓ Ripe Wagering-Contract Rule or Ripe-Time Rule.

15. The method of claim 14, wherein the outcome notification system is a quick and easy method for Member-Players to submit their Conforming Outcome Messages to The Confirming Server, and said method of notification is programmed into The Confirming Server's database, web-domain, web-pages, and/or computer/Internet server potentially managed by a master controller.

16. The method of claim 15, wherein the notification method comprises either an email reply, email forward, or through using an In-House communication system.

17. The method of claim 15, further comprising the step of a computer server, browser, and/or master controller being programmed to communicate and present The Confirming Server's instructions and rules regarding the Conforming Outcome Message notification, authentication, and verification system to the Member-Players before suspending wagered funds and applying the Conforming Outcome Message rules.

18. The method of claim 17, further comprising the step of a computer server, browser, and/or master controller being programmed to communicate, present, and apply the following rules involving the Conforming Outcome Messages notification system and Member-Player obligations, particularly the events that will breach the wagering contract and cause subsequent placement on the Watch List:
that in the event that only one of the Member-Players (or one team of Member-Players for multiplayer Gaming Events) submits the required Outcome Information, it is the complying/non-breaching Member-Player(s) The Confirming Server will deem the Winning Player(s) and subsequent recipient of the wagered money amounts;
that in the event the Member-Players tender back to The Confirming Server conflicting or otherwise non-conforming Outcome Information pertaining to their Gaming Event, the contract will be voided subject to any fee, and both or all Member-Players involved in the disputed Gaming Event will be deemed in breach and become breaching Member-Players regardless of Actual Outcome;
any breaching Member-Player will automatically be placed on the Watch List and become subject to its Warning System;
these warnings will appear before final entry of any contract and suspending of wagered funds involving the breaching Member-Player and an unknowing/Member-Player and will last for two weeks (or other time) after the first breach;
these warnings will last for one month (or other time and may potentially involve higher processing fees) after a Member-Player's second breach; and
in the event any Member-Player breaches the terms of The Confirming Server including the Conforming Outcome Message requirement three times in a six month period (or other specified period), that repeating breaching Member-Player will have his membership suspended or will otherwise be penalized.

19. The method of claim 18, further comprising the step of a computer server, browser, and/or master controller being programmed to communicate, present, and apply the rules and terms regarding Watch list and Warning System whereby any unknowing/Member-Player about to become a party to a wagering agreement with a breaching Member-Player on the Watch List receives a warning from The Confirming Server attempting to dissuade the unknowing/Member-Player from contracting with the breaching Member-Player and suggesting extra caution in dealing with that breaching Member-Player because all Member-Players involved in conflicting Outcome Information are deemed in breach and will be placed on the Watch List regardless of fault.

20. The method of claim 18, further comprising the step of a computer server, browser, and/or master controller being programmed to communicate, present, and apply The Confirming Server's terms regarding the ⅓ Ripe Wagering-Contract Rule and Ripe-Time Rule, particularly that a Wagering Contract ripens after ⅓ of a Complete Gaming Event occurs or it ripens after expiration of a specified time limit accruing from the point the wagered funds are submitted or time after which contracting Member-Players designate, and Outcome Information identifying a Winning Player will be required from the Member-Players irrespective of any excuse, intent, or glitch in the online game-play [stated otherwise, the Point-of-No-Return wherein a Winning Player must be identified by the Member-Players party to the wagering contract no matter what]; including The Confirming Server's time-keeping mechanism that will automatically start (or delayed start if otherwise agreed) upon submitting the final contracts.

21. The method of claim 20, wherein the Point-of-no-Return concept is practiced as a ½, ¼, ⅕, ⅙, 1/7, ⅛, 1/9, or other fraction of a Complete Gaming Event or expiration of a time limit accruing from the point the wagered funds are submitted.

22. A system for conducting e-commerce over the Internet comprising a computer server, browser, and/or master controller being programmed to: (i) communicate and present to Member-Players via the Internet data representing the embodiment of The Confirming Server; (ii) accept computer communication via the Internet from Member-Players using their personal computer devices; (iii) apply the terms and rules communicated and presented to Member-Players; (iv) implement and provide a ranking score of Member-Players' reputation for compliance with the terms and rules; (v) maintain, manage, and move money accounts; (vi) process payment information; (vii) receive and verify conformance of outcome information; and (viii) move the suspended wagered funds from the pending contracts account to the winning player's segregated membership account where such funds become available for withdraw or further wagering activity; and (ix) implement and provide an incentive system for rewarding Member-Players' compliance with terms and rules.

23. The system of claim 22, wherein the communications, presentations, and other information comprises computer-executable code sent from The Confirming Server to Member-Players over the Internet network.

24. The method of claim 22 for automatically monitoring and regulating the wagering activity of a Member-Player, particularly, further comprising the step of periodically notifying the individual of current monetary amounts expended, current gaming time expended by that Member-Player, and Watch List status when applicable.

25. The method of claim 22, further comprising varying presentations and multiple servers programmed to charge a Rake [defined as a processing fee assessed according to a percentage of the total amount wagered], membership fee assessed annually, biannually, monthly, or any other membership fee collection method dependent upon a state's or other governing municipality's law regarding wagering/gambling agreements.
